(19) United States
(12) Patent Application Publication
(10) Pub. No.: US 2012/0089418 A1
(43) Pub. Date: Apr. 12, 2012

(54) INTEGRATED INTERACTIVE SYSTEMS AND METHODS WITH SINGLE TRANSACTIONAL DATABASE AND REPORTING APPLICATION FOR eCLINICAL TRIALS

(76) Inventors: Shwetha Ramachandra Kamath, Edison, NJ (US); Fnu Ananda, Edison, NJ (US); Vishnu Ramachandra Kamath, Upudi (IN)

(21) Appl. No.: 12/901,698

(22) Filed: Oct. 11, 2010

(51) Int. Cl. G06Q 50/00; G06Q 10/00

(52) U.S. Cl. 705/3

(57) ABSTRACT

The present invention relates to a fully integrated systems and methods to offer end-to-end solution in designing, managing, recording, analyzing, mining and reporting of traditional as well as adaptive clinical trials with single transaction database. Particularly, the present invention relates to a system and method for clinical trial which will help pharmaceuticals/biotech/medical device companies and clinical research organizations (CROs) to manage various activities as per the business flow of a clinical trial, right from protocol design to submission of clinical study reports through their various functionalities/modules. Specifically, the present invention is suitable for adaptive clinical trials where the clinical plans are modified based on the results obtained in the single or multiple interim data analysis. More specifically, the present invention offers a closed loop feedback control of trial parameters and expectations to enhance trial success and addresses safety and efficacy concerns without compromising blinding and statistical validity.

### FIELD OF INVENTION

The present invention relates to a fully integrated systems and methods to offer end-to-end solution in designing, managing, recording, analyzing, mining and reporting of traditional as well as adaptive clinical trials with single transaction database with a reporting data warehouse application for reporting and managing trial set up and submission using multiple channels of communication with closed loop feedback control of trial parameters. The present invention relates to a system and method for clinical trial which will help pharmaceuticals/biotech/medical device companies and clinical research organizations (CROs) to manage various activities as per the business flow of a clinical trial, right from protocol design to submission of clinical study reports through their various functionalities/modules which are fully integrated. Specifically, the present invention is suitable for adaptive clinical trials where the clinical plans are modified based on the results obtained in the single or multiple interim data analysis. More specifically, the present invention offers a closed loop feedback control of trial parameters and expectations to enhance trial success and addresses safety and efficacy concerns without compromising blinding and statistical validity.

### BACKGROUND

Clinical trials are critical and complex part of drug development process. The clinical trials make drug development process a long and expensive one. Considering very low success rate involved in clinical phase of the drug development process, the pharmaceuticals, biotech and medical device companies carry high risk with respect to budget, time and resources while carrying out clinical trials.

According to Food and Drug Administration's (FDA) Critical Path Initiative (CPI), despite important investments in basic biomedical research, the number of NDA (New Drug Application) to the FDA for new drugs and biologics has declined over the past decade. Of more concern, drug development is not becoming more efficient over time—a drug entering Phase 1 trials in 2000 was not more likely to reach the market than one entering Phase 1 trials in 1985. And there occurs more drug candidate failures in the later stages of drug development. Therefore, there is tremendous pressure on these companies to maximize the value of their research and development efforts by creating productivity and further efficiency and by reducing budget of clinical trials.

To manage a clinical trial, it requires support and co-ordination between various spiraling activities in areas like identification of potential subjects, designing of clinical trial, patient randomization, collection of the data, reporting patient's outcomes and adverse events, managing clinical supplies including study medications, imaging and annotating, getting updates on the status of clinical trial, controlling budgets, processing and analysis of clean data, preparation and submission of clinical study reports and data as per the standards. To ensure successful completion of a clinical trial, one has to manage these various areas of a clinical trial effectively in a well coordinated and integrated manner, so that duplicate entry of data and reconciliation is minimized or eliminated completely.

Therefore, the use of information technology in management of clinical trials is very critical. US FDA critical path initiative also supports use of information technology to overcome rising difficulties and unpredictability of drug development process and improve the success rate by allowing for prospective changes based on interim analysis and this requires clinical trials to be more adaptive. Adaptive trials necessitate analysis of clean data and control of trial parameters rapidly and sometimes instantaneously.

Presently, clinical trials are managed with silos with multiple databases and applications or partly integrated silos with scattered databases among the vendors and sponsors, making adaptiveness difficult due to duplicate data, multiple support groups, reconciliation efforts, migration hurdles due to multiple user-ids and passwords of silo-based databases creating issues on inconsistencies and integrity. The sponsor companies and Clinical Research Organizations (CROs) use various vendors and different applications to manage various areas of the clinical trials like electronic data capture (EDC), patient randomization (IVRS/IWRS), Clinical trial management (CTMS) and data management etc., causing no uniformity in data and reports presented to regulatory authorities.

In such scenarios, it is becoming increasingly difficult to integrate various applications externally due to incompatibility of other applications/technologies and vendors related issues and service level agreements. In a landscape that contains many dozens of vendors, applications, support groups and large IT staffing, simplification through integration is fast becoming imperative to have rapid processing of data coming from various areas and to have real time updates on clinical trial expectations. Also, to fulfill the industry's goals, there is a strong need of a fully integrated system with single transaction database which will enable rapid processing of the information through various functionalities/modules from various functional various areas, such as clinical supplies, data management, medical affairs, clinical operations, statistical analysis, quality control, regulatory and finance and provide the constant updates as the trial/s move along.

WO2004038560 relates to various applications required for clinical trial process which does not mention about functionalities like randomization, clinical labeling, just-in-time, Data SQC, Experimental design, IVRS/IWRS, Pharmacovigilance, e-diary, component authoring, medical writing, standard data management and master data management module as in the present invention. The cited patent also does not mention about applicability of adaptive clinical trial.

WO200193160 relates to an internet based clinical management system which does not offer Clinical labeling, data SQC, pharmacovigilance, experimental design, component authoring, medical writing, master data management and standard data managements as done by the present invention. It also does not provide for adaptive clinical trial.

WO2004102333 discloses a centralized, online clinical study system through which clinical trials can be managed, administered and performed. It does not contain the functionalities included in the present invention like Pharmacovigilance, data SQC, experimental design, imaging, clinical labeling, IVRS/IWRS, component authoring, medical writing, master data management, Clinical Study Reporting for reporting on safety and efficacy, and standard data managements and it also does not provide for adaptive clinical trials.

WO2008134233 relates to a method and system which are described for centrally managing data in an adaptive clinical trial or other adaptive process that is conducted at a plurality of geographically remote sites. Although adaptive feature is common in the present invention, the functionalities like IVRS/IWRS, AERS, Pharmacovigilance, e-diary, data SQC, clinical labeling, just-in-time labeling and inventory control, experimental design, component authoring, master data management and standard data managements are not there in the cited text. Again the cited invention does not provide reporting systems like CSR and CTR that the present invention is offering.

WO2009155558 discloses a system and method that allow interacting with clinical trial operational data for easy accessibility, re-usability of software and centralized use of operational data and software for conducting clinical trials based on semantics as well as syntax for consistency. The system is limited only to clinical trial management system whereas the present invention provides all the modules/functionalities for designing, managing, recording and reporting of clinical trial.

US20050038673 discloses a system for automated management of a clinical trial for pharmaceutical, biomedical, and medical device development that facilitates pharmaceutical research and reporting. Unlike the present invention, the cited patent does not cover the functionalities like IVRS/IWRS, AERS, Pharmacovigilance, e-diary, data SQC, clinical labeling, Just-in-time labeling and inventory control, experimental design, component authoring, medical writing, master data management and standard data managements.

WO2010078632 discloses a system and method for definition, acquisition and management of clinical trial data and also talks about electronic data capture, multilingual support. There is no mention of functionalities like IVRS/IWRS, AERS, Pharmacovigilance, e-diary, data SQC, clinical labeling, experimental design, component authoring, medical writing, master data management and standard data managements, CTR and CSR and also it does not contain any claim on suitability for adaptive clinical trial.

U.S. Pat. No. 7,251,609 encompasses a method of conducting a clinical trial of the effectiveness of a test substance administered to a test participant from a primary site, via the internet.

US20100023870 discloses an apparatus and methods to implement a computer-based system and procedure for the efficient and effective operation of one or more clinical trials using an IRB. Each authorized participant in the clinical trial can have a customized and customizable view of the clinical trial and interact with the other participants electronically.

JP2002041657 relates to integrated clinical trial management system which has a means for being entrusted with clinical trial business from the clinical trial client in the clinical trial of new medicine, a means for selecting a clinical trial performer and a subject who is suitable to the set condition of the clinical trial client, a means for urging the clinical trial performer to perform clinical trial of the subject, a means for collecting clinical trial results from the clinical trial performer, and a means for providing the clinical trial client with the clinical trial results.

None of the above cited patents provides for an end-to-end solution right from designing clinical trial protocol to the generating of clinical study reports online and a system which is more suitable for adaptive clinical trials with closed loop feedback control on trial parameters and expectations. Therefore, there exist a need for a method and system for clinical trial, which is fully integrated, provided end to end to solution to support various areas of clinical trials and which overcomes various issues involved in managing various vendors and different applications that industry is facing at present.

### OBJECTIVE

It is the primary object of the present invention to provide a fully integrated systems and methods to offer end-to-end solution in designing, managing, mining, following standards, recording, analyzing and reporting of traditional as well as adaptive clinical trials with single transaction database with closed loop feedback control on trial expectations and parameters.

It is another object of the present invention to provide a system and method to support conduct of a clinical trial with single transaction database with a reporting data warehouse application using multiple channels of communication.

It is another object of the present invention, wherein the system and method will help pharmaceuticals/biotech/medical device companies and clinical research organizations (CROs) to manage various activities as per the business flow of a clinical trial, right from protocol design to submission of clinical study reports through their various functionalities/modules which are fully integrated.

It is another object of the present invention, which describes single database system which takes information from multiple channels of communication.

It is yet another object of the present invention which describes a single transactional repository with a pyramidal architecture which can take clinical trials from silos to fully integrated ones.

It is another object of the present invention, wherein the system and method will help the companies to achieve their goals with respect to—
Reduced clinical project duration
Enhanced effectiveness of trial management
Reduced clinical trial budget
Increased clinical trial success rate
Improved drug development process and quality

It is yet another object of the present invention, wherein the system and method is specifically suitable for adaptive clinical trials where the clinical plans are modified as per prospective changes based on the results obtained in the interim data analysis on trial parameters and expectations.

It is yet another object of the present invention, wherein the system and method offer a great flexibility to accommodate the changes/amendments that may occur to clinical trials plan, as the study is conducted and feedback received on trial parameters and expectations.

It is yet another object of the present invention, wherein the system offers a closed loop feedback control system to enhance trial success and address safety concerns without compromising blinding and statistical validity.

It is yet another object of the present invention, wherein the invention supports FDA's critical path initiative to modernize clinical trial industry to improve trial success rates.

It is another object of the present invention, wherein the system offers many different modules in one system to support clinical trial requirements in various areas like clinical trial management system (CTMS), electronic data capture (EDC), e-diary, IVRS/IWRS (interactive voice/web response system), administration/security, clinical labeling, adverse event reporting system, randomization, imaging, experimental design, data/image/voice mining, data SQC with provision for quality control and quality assurance and pharmacovigilance.

It is yet another object of the present invention, wherein the system is a single data login system which provides single data point of information and ensures smooth flow of the information from one component to others due to its single transactional repository and common component based architecture and thereby avoid need for the duplicate entries

It is yet another object of the present invention, wherein the system provides real time update of the clinical trial like status of investigational sites, treatment effect, clinical study/program status, finances, clean data and safety data

It is yet another object of the present invention, wherein the system provides updated, accurate Clinical Trial Reports (CTR) on operational metrics which can be part of MIS (Management Information System).

It is yet another object of the present invention, wherein the system provides data warehouse web application built using Business Intelligence (BI) and Data Intelligence (DI) tools with ability to access real time mission critical information and report on global data management.

It is yet another object of the present invention, wherein the system has foundation repository and provides statistical computing environment for both scientific (safety and efficacy at protocol and project level) and operational metrics (trial details, GANTT charts on milestones, enrollment chart, trial finances at protocol and project level).

It is yet another object of the present invention, wherein the system offers Master Data Management, Standard and Meta data Management modules, Experimental design and simulation, data transformation, analysis, and reporting through pooling of data either across or within individual studies.

It is yet another object of the present invention, wherein the system offers component authoring for assembling key project information like clinical development plan and submission.

It is yet another object of the present invention, wherein the system offers study documentation like protocol and clinical study reports.

It is yet another object of the present invention, wherein the system has flexibility of generating operational, scientific reports and provides for data, text and image mining for Business Intelligence as per users' requirements with provision for archiving data and formats in XML files enabling retrieval of data and formats at a future date.

### SUMMARY

Thus according to the basic aspect of the present invention there is provided a fully integrated, single transactional online system for end-to-end solution in mining, designing, managing, recording, analyzing and reporting of traditional as well as adaptive clinical trials comprising:

single transactional system;
reporting system;
application server;
web server;
interactive voice response server; and
communication network,
wherein the application server is configured to perform clinical trial functions,
wherein the web server coupled to the application server has an user interface to facilitate access to clinical trial functions over an internet based network,
wherein the communication network includes ISP (Internet Service Provider)/PSTN (Public Switched Telephone Network)/GSM, (Global System Mobile)
wherein the single transaction database uses multiple channels of communication,
wherein the system has a single transactional repository with a pyramidal architecture to take clinical trials from silos to fully integrated ones,
wherein the system has a single data login system which provides single data point of information and ensures smooth flow of the information from one component to others, and
wherein the system provides real time update of the clinical trial that includes status of investigational sites, treatment effect, clinical study/program status, finances, clean data and safety data.

In another aspect of the invention there is provided a fully integrated, single transactional online system, wherein the transactional database system consists of a plurality of applications selected from the group consisting of:

clinical trial management system (CTMS);
electronic data capture (EDC);
e-diary;
data mining;
IVRS/IWRS (interactive voice/web response system);
medical imaging;
administration/security;
clinical drug labeling;
adverse event reporting system;
randomization;
experimental design;
data SQC; and

### Pharmacovigilance

In yet another aspect of the invention there is provided a fully integrated, single transactional online system, wherein the reporting system consists of a plurality of applications selected from the group consisting of:

data warehouse web application;
clinical trial report;
clinical study report;
component authoring;
master data management;
standards management; and
medical writing
wherein the data warehouse web application is built using business intelligence (BI) and data intelligence (DI) tools with ability to access real time mission critical information.

In another preferred aspect of the invention there is provided a fully integrated, single transactional online system, wherein the clinical trial management system is configured to manage contacts, accounts, contracts and agreements to build protocols, construct and approve budgets, monitor payments, track protocol milestones, track site and patients status, upload and manage different kinds of documents, build templates for milestones, file checklist, visit report etc, to get critical clinical trial status reports for management information.

In yet another preferred aspect of the invention there is provided a fully integrated, single transactional online system, wherein the electronic data capture module is configured to transfer/obtain secured data in real-time from investigational sites.

In another aspect of the invention there is provided a fully integrated, single transactional online system, wherein the e-diary module provides interfaces to enter subject's health status data and quality of life, health economics and efficacy assessments via personal digital assistants (PDA), mobile, and interactive voice response system (IVRS).

In another aspect of the invention there is provided a fully integrated, single transactional online system, wherein the data mining tool enables identification of potential subjects suitable for a given clinical trials based on disease characteristics and co-morbidity rates based on electronic medical records and electronic health records and provide for identifying safety and efficacy patterns based on trial data.

In another aspect of the invention there is provided a fully integrated, single transactional online system, wherein the medical imaging module electronically stores, retrieves, transmits, displays and manages digital clinical images and enables computational organ dynamics for quantitative study.

In another aspect of the invention there is provided a fully integrated, single transactional online system, wherein the administration module is configured to provide various features that includes:

creation of users, languages, countries and currencies,
access to different modules, roles and sub roles for different users,
allow association of users with protocols and management of user sessions,
allow unlocking of protocols, and
allow viewing of system access logs and system related audit trails.

In another aspect of the invention there is provided a fully integrated, single transactional online system, wherein the clinical drug labeling functionality is configured to control drug supply just-in-time by making shipping requests and receipt confirmation over IVRS/IWRA (interactive voice/web response system) using bar coding and RFID (Radio-Frequency Identification) to enable drug accountability.

In another aspect of the invention there is provided a fully integrated, single transactional online system, wherein the adverse event reporting system is configured to provide for instantaneous AE/SAE alerts, email notification of AE/SAEs, AE/SAEs reconciliation, efficient tracking of AEs and SAEs, dictionary coding with auto encoding for MedDRA/WHO Drug dictionaries and audit trail-report showing audit trail for different data points.

In another aspect of the invention there is provided a fully integrated, single transactional online system, wherein the randomization functionality is configured to manage inventory dynamically by tracking enrollment rate, generate instant reports to view treatment distribution and balance across strata, implement complex randomization schemes, provide for transparency for the sites when treatment arms are removed, allow secured data transfer with real-time access to date and allow logical detection of random codes.

In another aspect of the invention there is provided a fully integrated, single transactional online system, wherein the experimental design is configured to provide a clinical trial design according to the number of groups, analysis basis, trial endpoint, sample allocations and data plotting.

In another aspect of the invention there is provided a fully integrated, single transactional online system, wherein the data sampling quality control module samples the entered data by allowing selection of different e CRFs and data points and assess whether the data is within the required quality limits based on quality control and quality assurance parameters and assists the user in sampling the data during the trial for quality control (QC) and quality assurance (QA) of data entry that has already been made.

In another aspect of the invention there is provided a fully integrated, single transactional online system, wherein the pharmacovigilance module is configured for post marketing safety surveillance, signal detection and reporting.

In another aspect of the invention there is provided a fully integrated, single transactional online system, wherein the clinical trial report application supports the creation and publication of status reports of the clinical projects for single or pooled protocols as the trial/s move along which provide vital information to the management group.

In another aspect of the invention there is provided a fully integrated, single transactional online system, wherein the clinical study reports functionality includes a web based graphical user interface which allows targeted end users to review and produce tables, listings and graphs as per ICH guidelines for single protocol or pooled protocols during the conduct of a clinical study.

In another aspect of the invention there is provided a fully integrated, single transactional online system, wherein the component authoring module assembles projects that includes clinical development plan, submission and study documentation that includes protocol and clinical study report from reusable content, structured fields such as title and ID and free texts such as study objectives.

In another aspect of the invention there is provided a fully integrated, single transactional online system, wherein the master data management module describes and maintains reference data selected from the group consisting of code lists, normal ranges, valid values and conversion factors.

In another aspect of the invention there is provided a fully integrated, single transactional online system, wherein the standard management module characterizes the study objects selected from the group consisting of datasets, e CRF screens code lists, based upon underlying defined concepts and business rules associated with those concepts with eCRFs created as per CDISC CDASH standards, value added datasets created as per CDISC SDTM standards, Analysis Data created as per CDISC AdaM compliant standards.

In another aspect of the invention there is provided a fully integrated, single transactional online system, wherein the medical writing module is configured to provide various standards templates for the regulatory documents that includes INDs, NDAs, CTDs, IND annual reports, protocol and protocol amendments, IBs, CSRs, subject and study narratives, publication documents and preparing manuscripts of higher quality.

### BRIEF DESCRIPTION OF THE DRAWINGS

FIG. 1 illustrates a closed loop feedback control using adaptive clinical trials;

FIG. 2 illustrates a fully integrated system with single transactional database with a dataware house application for reporting and management of clinical trials;

FIG. 3 illustrates the Pyramid Architecture of transactional modules of integrated system interaction with data warehouse components;

FIG. 4 illustrates the clinical trial process flows across different modules of integrated system and interaction of different users of a pharmaceutical company through different communication channels;

FIGS. 5.1-5.7 illustrate flow of clinical trial activities stated in the business flow according to the mentioned order and also show the screenshots of the integrated system wherever applicable;

FIG. 6 illustrates sub activities which are present in query management which is one of the ongoing activities present in the business flow;

FIG. 7 illustrates randomization of patient with respect to different study designs;

FIG. 8 illustrates how scalability of the system is improved and maintained by adding more web servers to the web server's clusters;

FIG. 9 illustrates the integration of two or more systems which will create a new silo based system;

FIG. 10 illustrates the value addition for adaptive trial; and

FIG. 11 illustrates the vision of the present invention.

### DETAILED DESCRIPTION

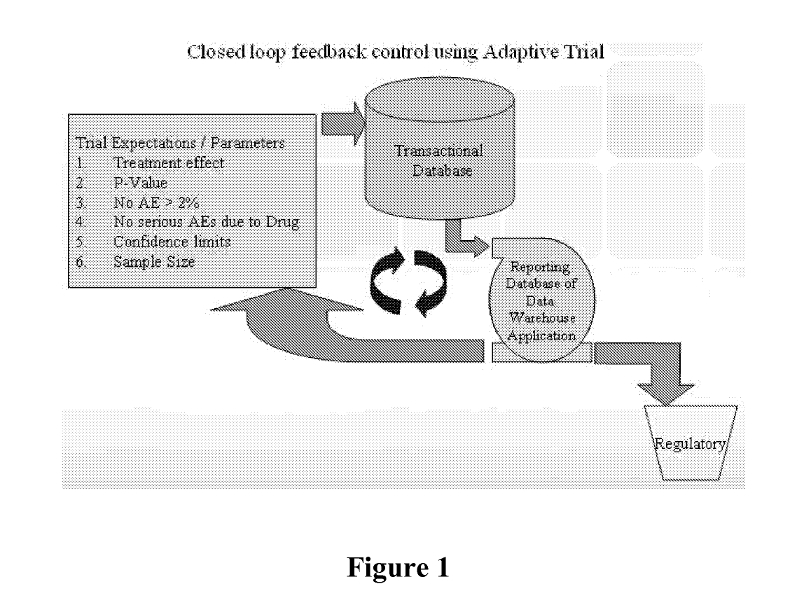

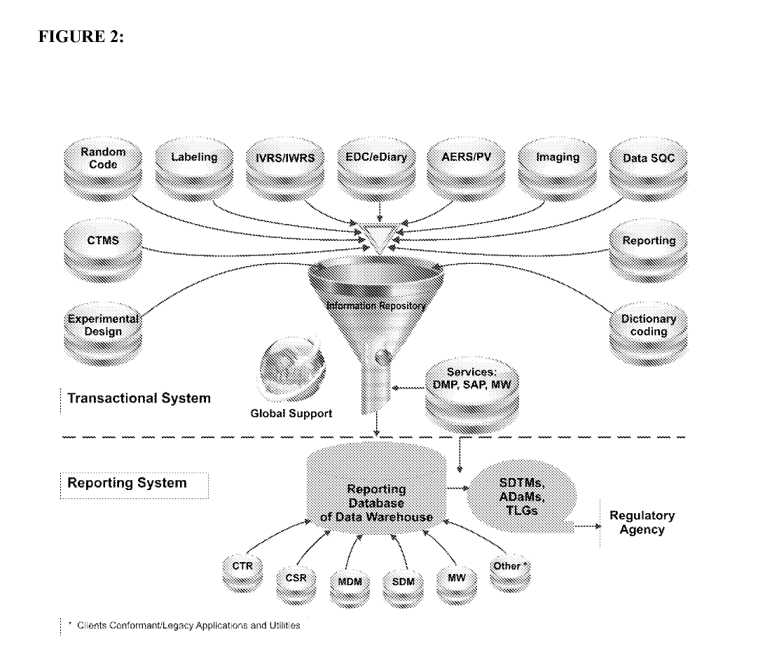

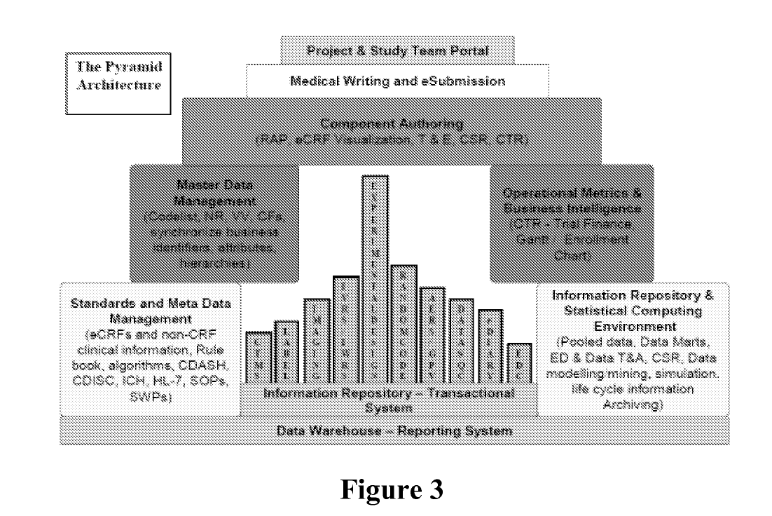

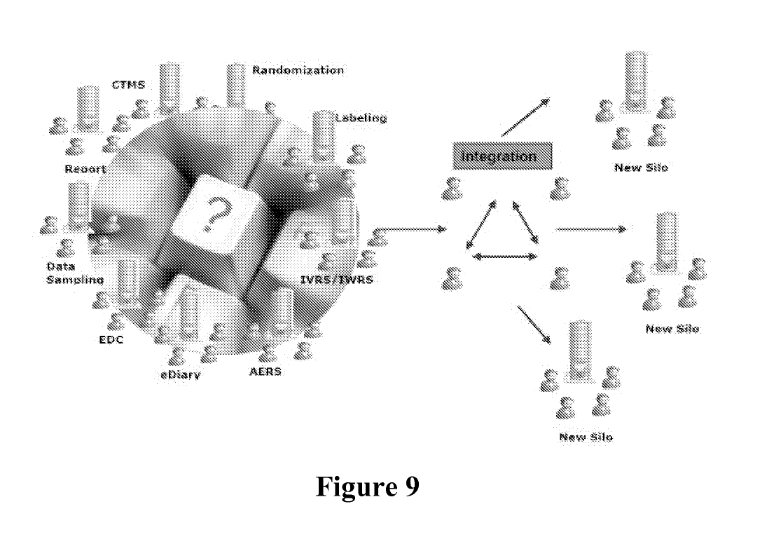

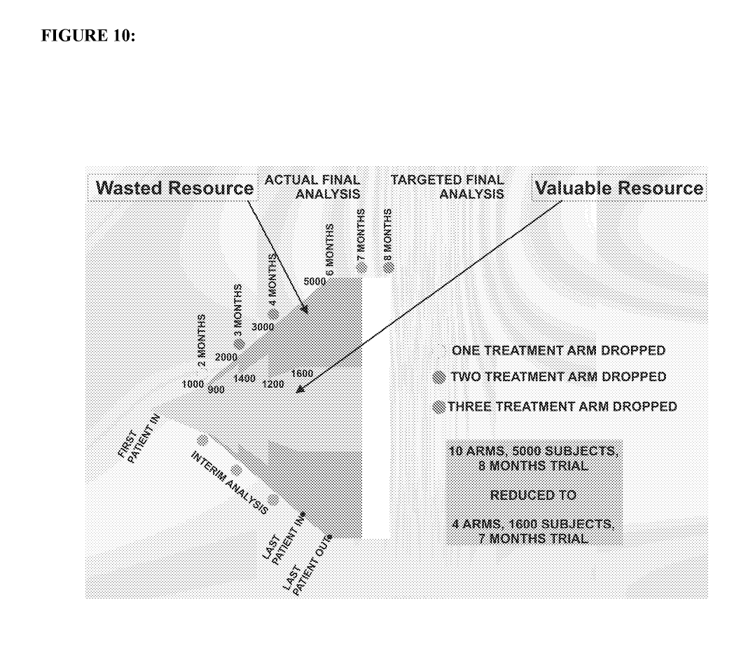

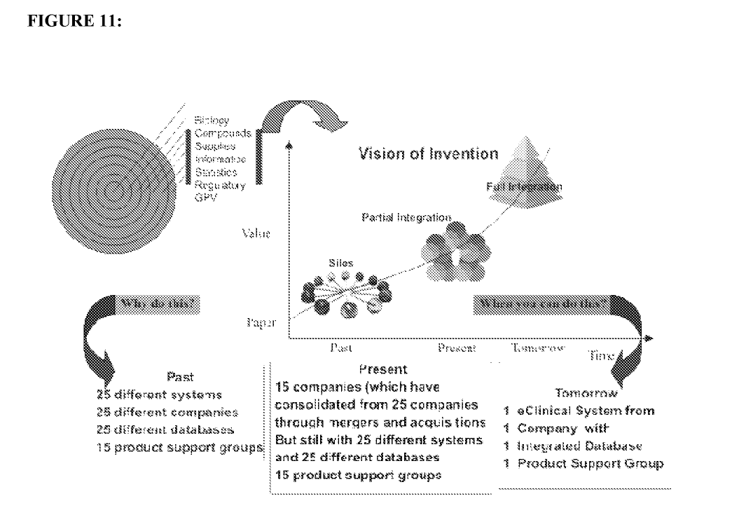

As stated above, the embodiment of the present invention relates to system and method to offer end-to-end solutions through various functionalities/modules to support phase I to phase IV clinical trials in a seamless phase and adaptive manner as illustrated in FIG. 2. The system offers a closed loop feedback control system to enhance trial success and address safety concerns without compromising blinding and statistical validity as illustrated in FIG. 1. This mission-critical invention supports the various areas of traditional as well as adaptive clinical trials. To improve the success rate of a clinical trial, the industry is moving from traditional silo based solution, provided by “best-in-class” multiple vendors, to single transaction database with a pyramidal architecture which can take clinical trials from silos to fully integrated best suitable for adaptive clinical trials as illustrated in FIG. 3 and FIG. 11. According to the working of the present invention, the integration of two or more systems will create a new silo based system, as illustrated in FIG. 9. The invention described here is more suitable for designing, managing, reporting, analyses, and recording of adaptive clinical trials, as these systems and methods provide for rapid adjustments to changing circumstances of the clinical trials as the trial/s move along as illustrated in FIG. 10. Thus, the invention described here supports FDA and industries initiative to improve the success rate of a clinical trial (Critical Path Initiative).

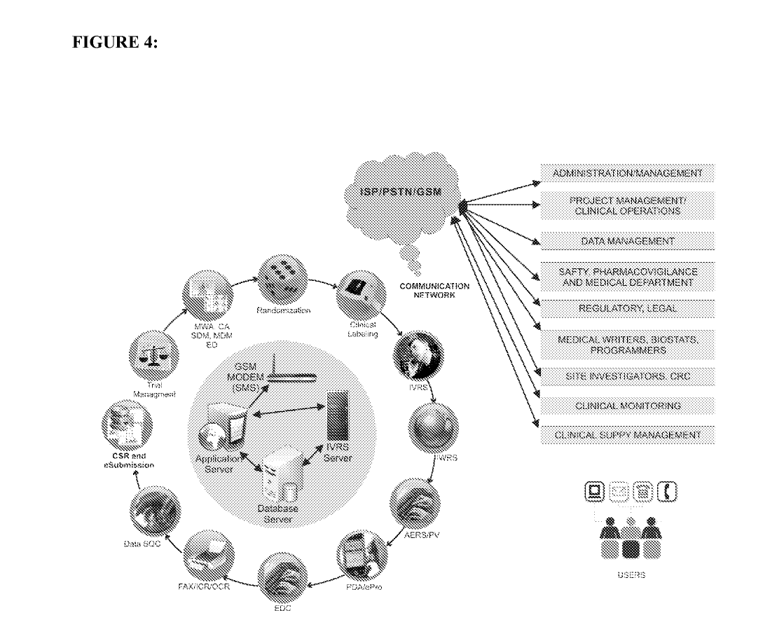

Also being fully integrated system with a single transaction information repository, this invention overcomes various issues involved in managing various vendors and different applications that industry is facing at present. The systems and methods available at present in the market provide integration of some of the functionalities like EDC, CTMS, IVRS, e-diary etc. However, the invention described here provides almost all functionalities/modules which are required for designing, managing, recording, analyses, and reporting of a clinical trial with complete integration as illustrated in FIG. 4. Considering the need of outsourcing of clinical trials in various regions, this type of systems which provide real time update of a clinical trial happening in one region to a sponsor based in another region and therefore the present system will be very much useful for the sponsor to take some critical decision during conduct of a clinical trial.

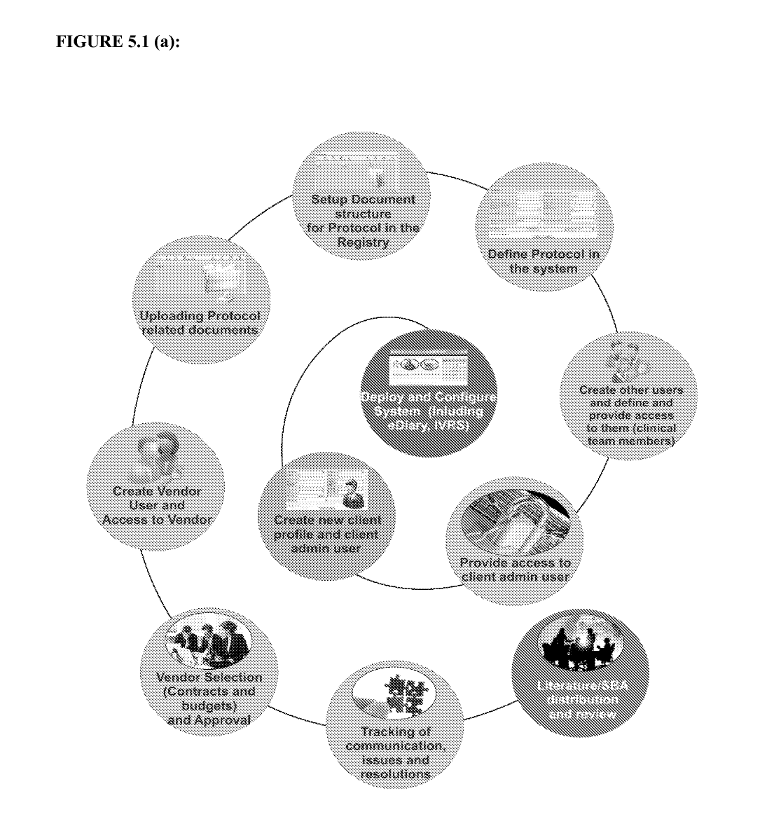

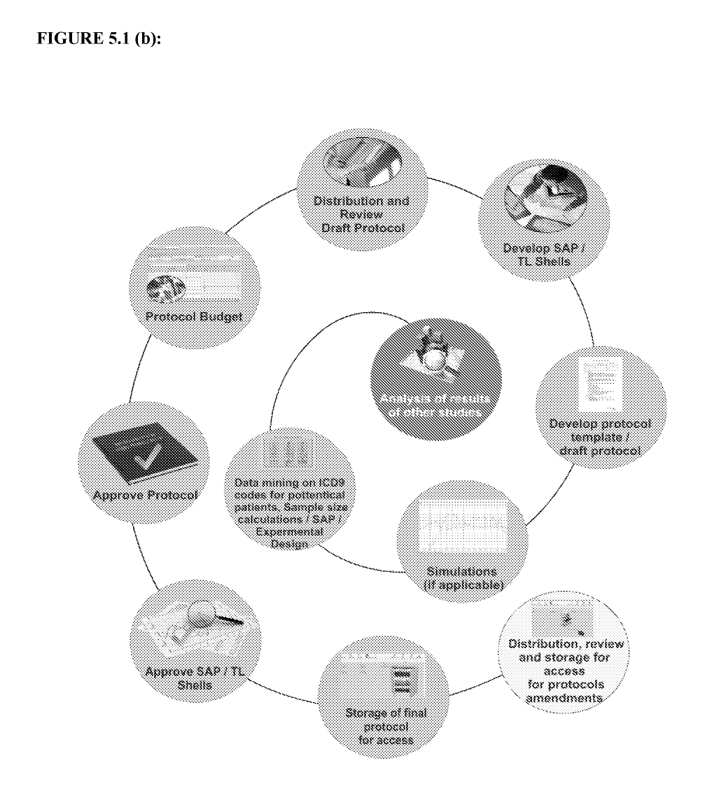

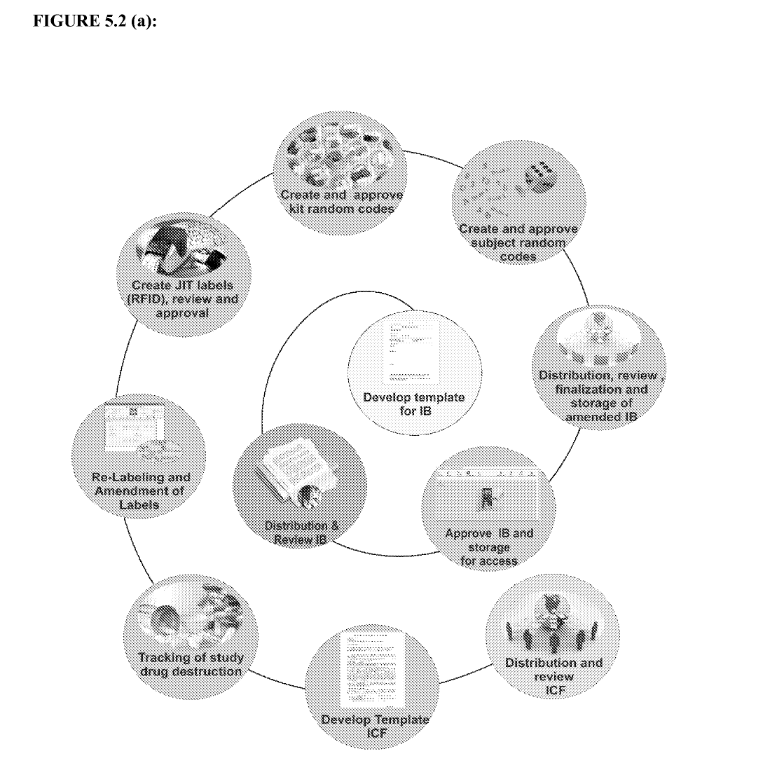

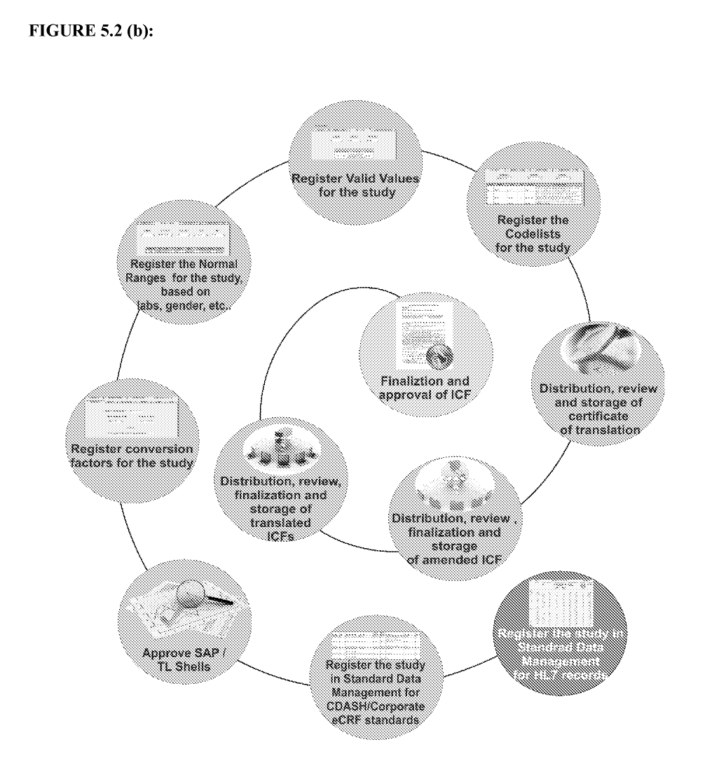

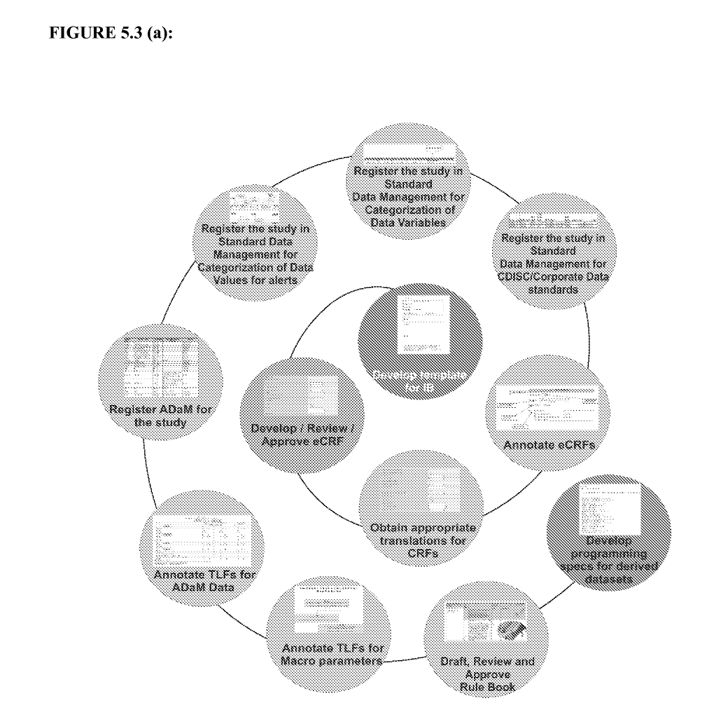

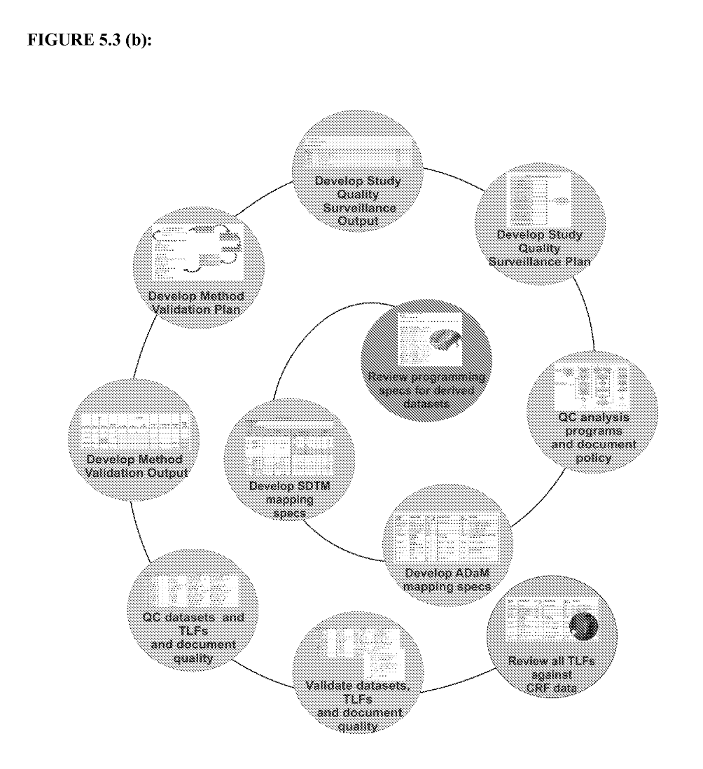

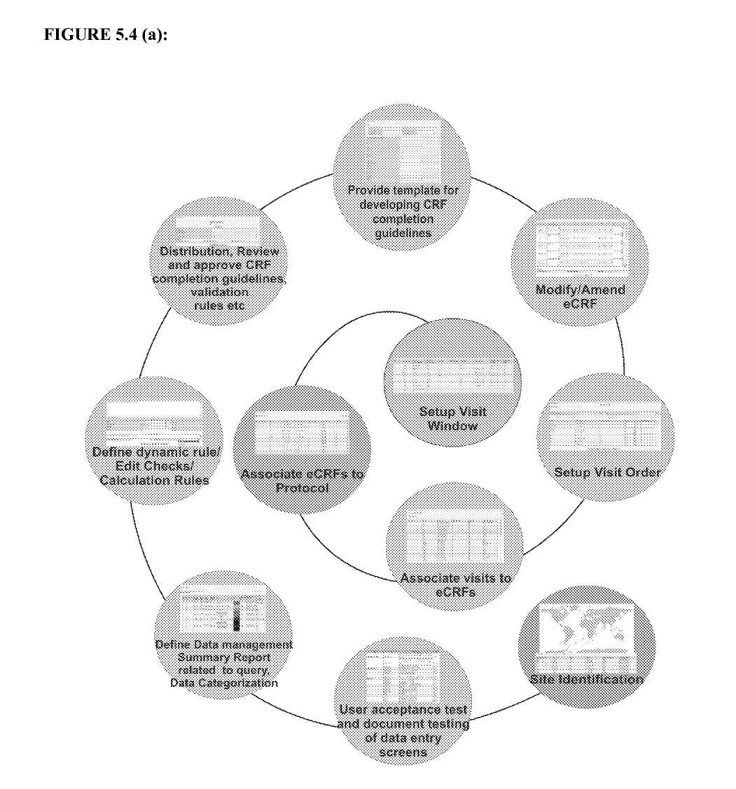

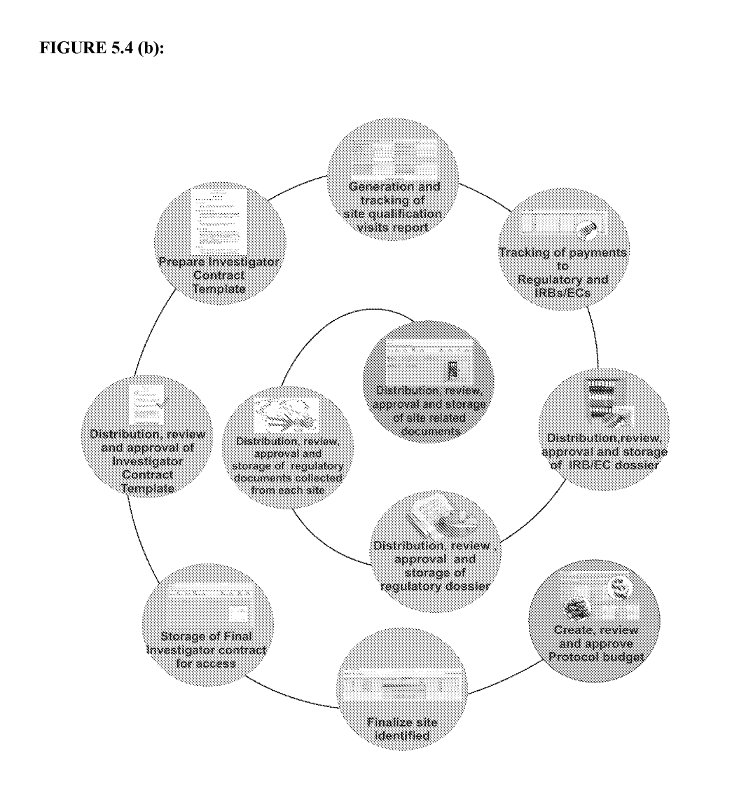

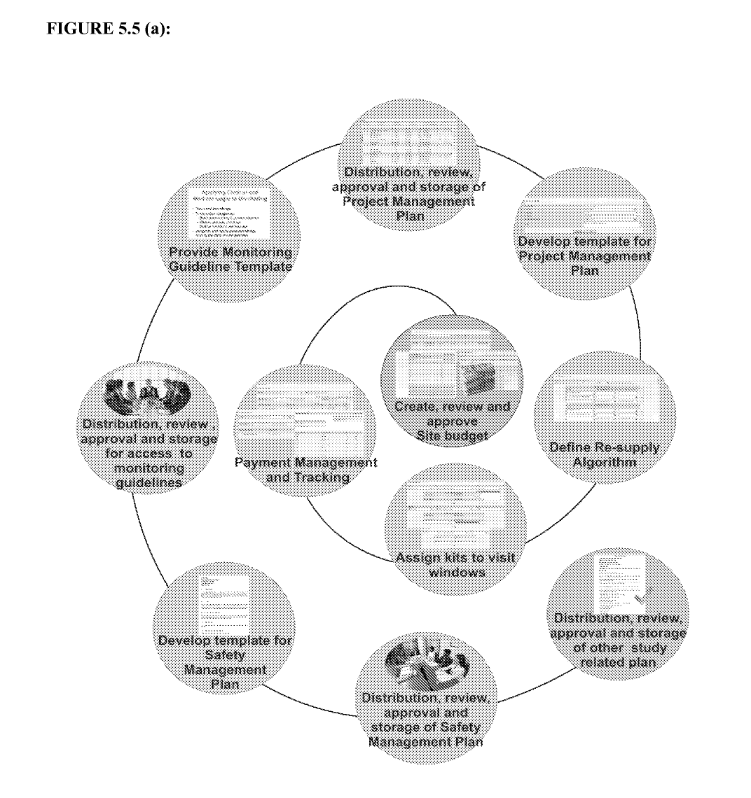

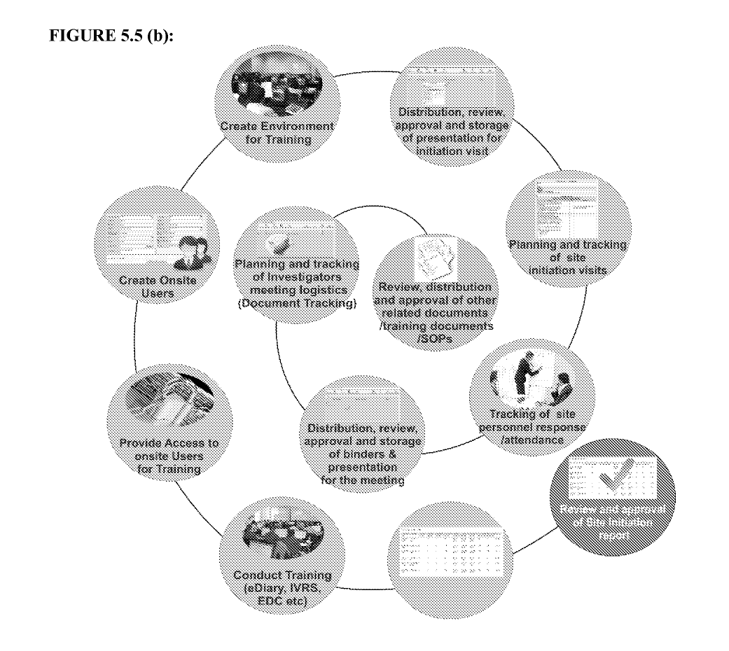

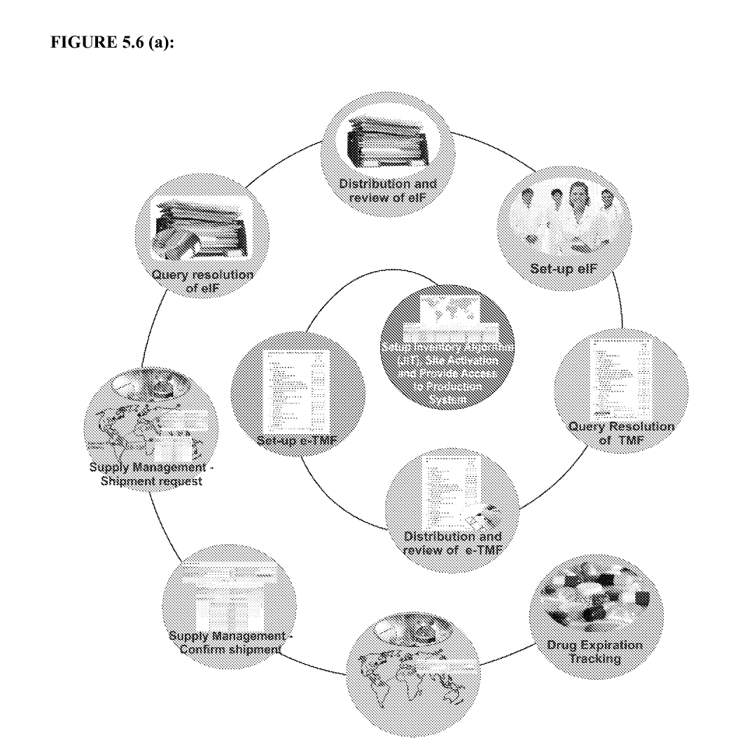

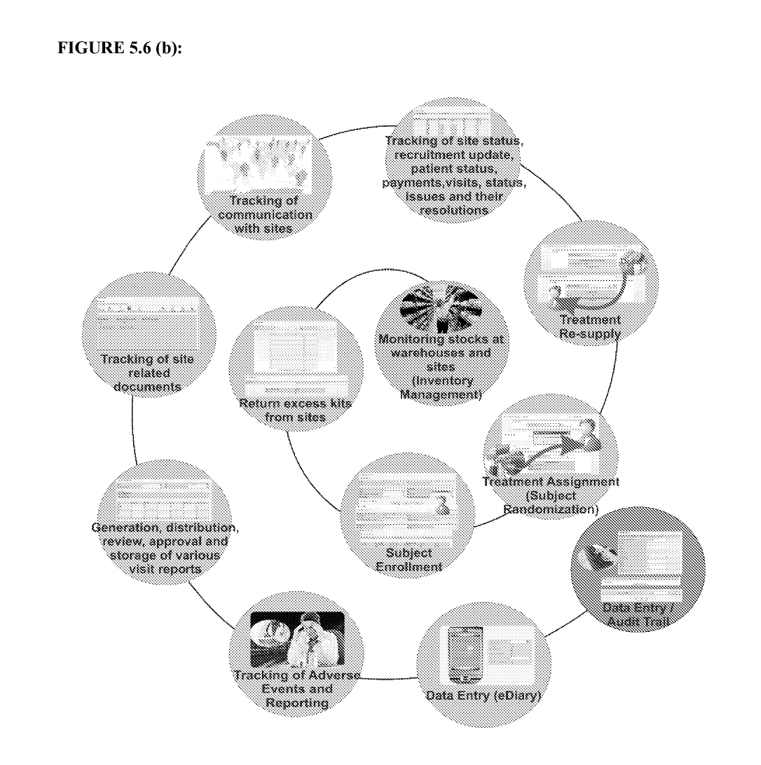

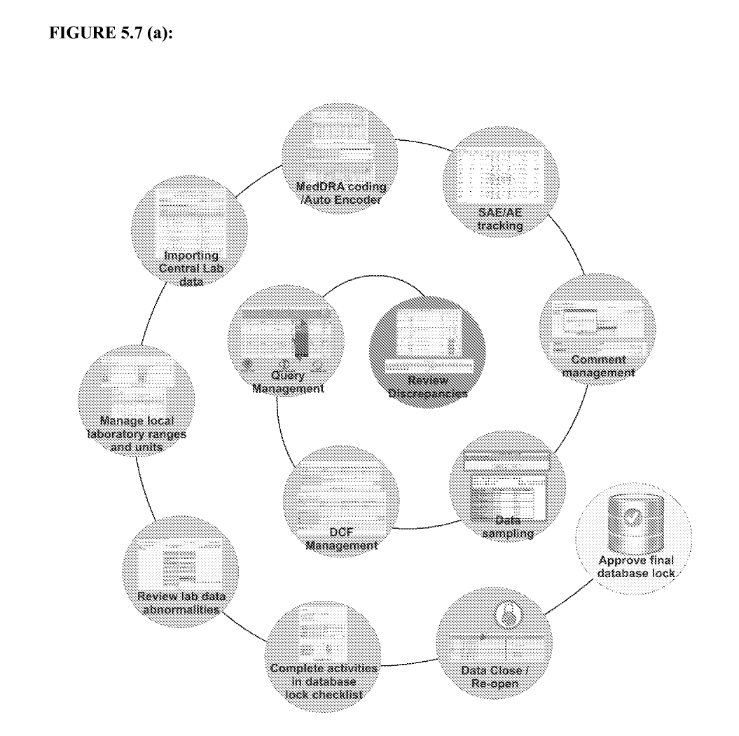

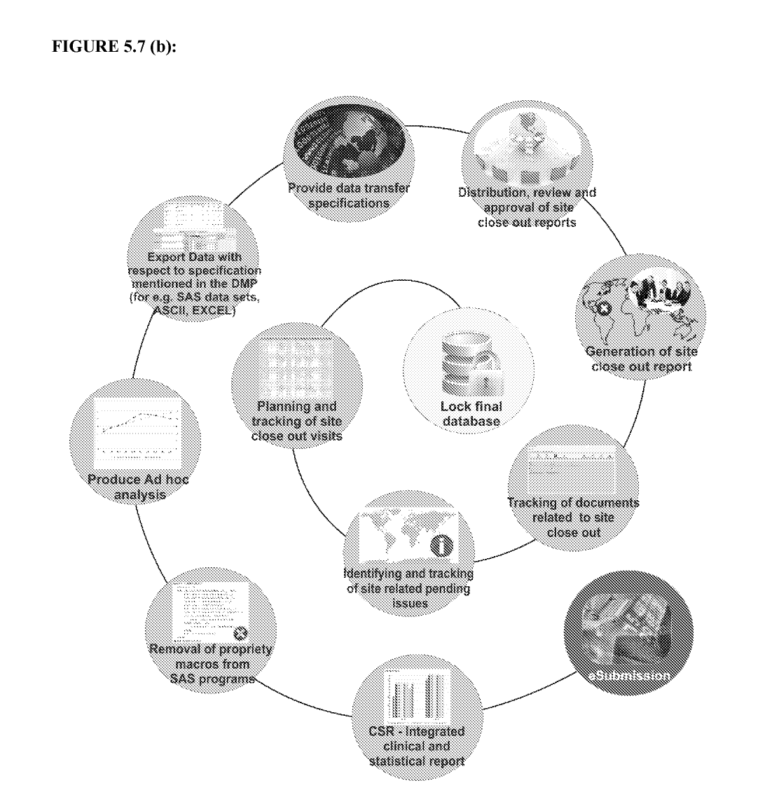

The way in which the various clinical trial activities are conducted and managed through the system provided in the present invention is illustrated sequentially through FIGS. 5.1 to 5.7. The following are the important features of the present invention, each of which individual features and functions are listed therein:

1. Clinical Trial Management System (CTMS):

The Clinical Trial Management functionalities/module of the system offers a very efficient way of setting up and managing clinical trials. It allows the Project Director/Manager to build protocols, construct and approve budgets, monitor payments, track protocol milestones, managing/tracking vendors, getting status reports, upload and manage different kinds of documents, and much more. The Project Director/Managers can efficiently and easily manage studies using some of the important features mentioned below.
Manage various contacts, accounts, contracts and agreements
Manage vendor requests, selection and approval for trials
Manage for single as well as multiple study phase trials
Allow creation and management of project plans for managing each trial
Present pending tasks for each user depending on the project plan
Add new panels and associate visits and panels with the study
Build protocols and construct budgets at protocol and site level
Track protocol milestones at various levels
Create and manage budgets, payments and grants for trial activities
Schedule and track patient visits and procedures
Schedule and track various visits to investigational sites
Tracking site status and patients status
Provide for automated payment requests based on subject visits
Approve automated as well as non-automated payment requests to make payments
Provide for efficient payment visit tracking
Efficient document tracking with provision for approval and rejection of document by approvers
Versioning of documents upon rejection
Provide for various kinds of trips reports template for site selection, initiation, monitoring and closing activities
Protocol amendment for facilitating change of protocol status for better flow of study
Provide for critical trial reports for the management information
Provide for milestone templates and file check list templates

2. Electronic Data Capture (EDC):

The system EDC module provides maximum flexibilities in the electronic Case Report Form (eCRF) design in multiple languages and time-line management. Rapid implementation and dynamic query management enables the efficient quality control of data. Periodic reports, alerts, and comments provide investigators with all the tools required for pro-active management.
Allow secured data transfer with real-time access to data
Track CRF design with flexibility in layout
Provide for final sign-off of captured data
Permit automatic tracking (Audit Trail) of status, queries, comments, and data changes providing compliance with 21 CFR Part 11.
Reduce duplicate queries on multiple CRFs—prevents piling up of queries towards the end of study
Provision for batch loading of lab data and normal ranges
Provide for code lists for having reusable data formats
Provide for source verification of data
Provide for alerts on patient visit schedules and violation

### Entering CRF Data

Allow dual data entry in hybrid mode
Allow data entry after selecting candidates and visits
Data entry is made easy and less error prone by providing for data selection objects like radio buttons, check boxes and pull down lists
Generate dynamic queries/edit checks if appropriate rule associated with the item is violated
Comments can be entered at the item (data-point) level, panel level, visit level, subject level and case book level

### Query Management

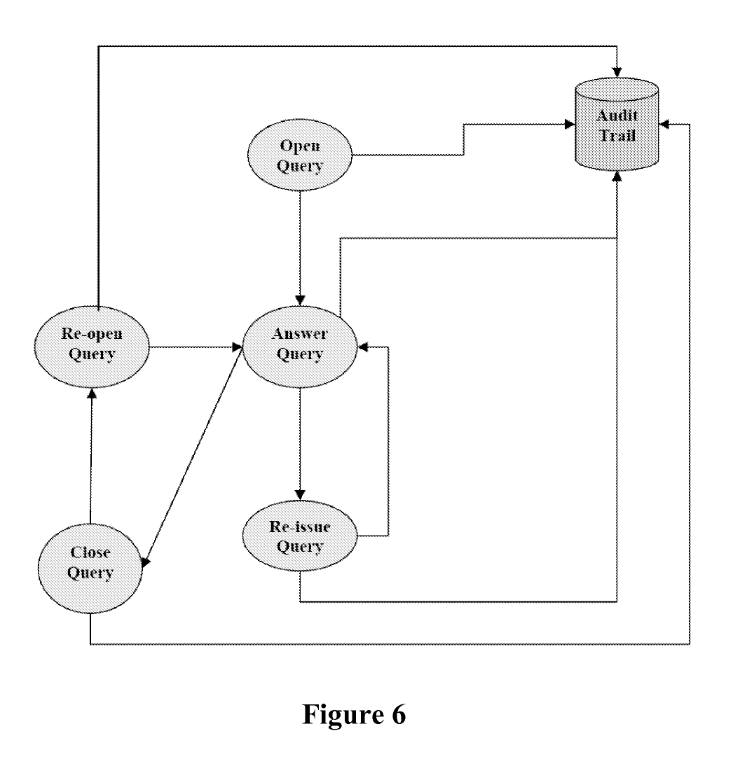

With reference to FIG. 6, which illustrates sub activities which are present in query management.
Provide for generation of queries manually (static queries) by the CRA or automatically (dynamic queries) by the system
Allow queries to exist in the following states: open (unresolved), answered (by site personnel), re-issued (re-opened), overruled and closed (resolved)
Provide for re-opening of closed/answered queries
Display the status of the panel for a visit through traffic lights
Brings up the panel by clicking on the traffic light for easy access of data
Provide “Manage Query” utility to get a list of queries in all states, allowing for direct access to queries by a few clicks
Provide utility for Data Clarification Management
   eCRF Listings, Signatures and Help
Generate instantaneous casebooks as pdf files by clicking on the casebook icon on each visit
Provide for electronic signatures at the casebook level, subject level and visit level
Provide for closing of data at casebook level, subject level and visit level, with a provision to allow some activities on data even after data closure
Help icons are present for all activities for utilization by users

### Reporting

Provide for Ad-hoc reporting on all data types in addition to various canned reports, utilizing varied arithmetic/logical operators using the advanced EDC Reporting Tool
Provide dashboard feature for instantaneous reporting of data missing, query aging, source verification, eSignature etc.

### Import/Export

Data import/export facilities to and from other applications
Allow for integration with e-Diary/ePRO

3. IVRS/IWRS (Interactive Voice/Web Reporting System)

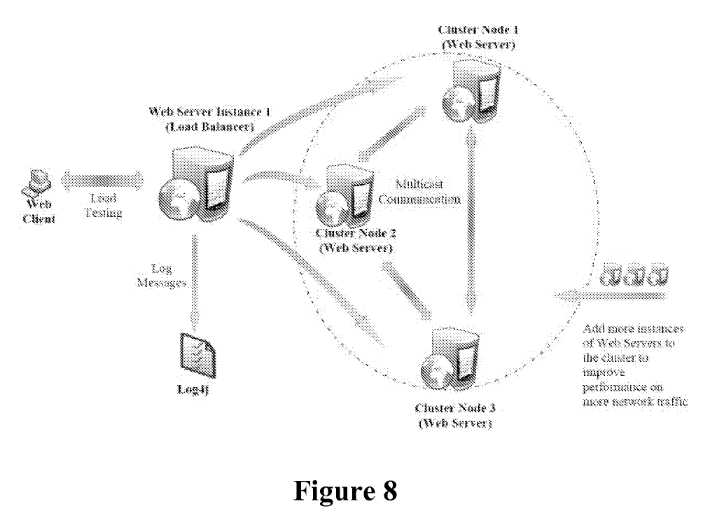

The system includes modules that offer the most advanced web-integrated Interactive Voice Response (IVR) system with speech recognition. A built-in inventory algorithm provides for the complete accountability of drug supplies and minimizes waste. Besides rapid implementation, a 24/7/365 support in multiple languages is available. A complex process that includes dynamic randomization is integrated within this module. The re-supply parameters are dynamically adjusted to accommodate consumption rate and delivery time. The scalability of the system can be improved and maintained by adding one or more web servers to the servers cluster as illustrated in FIG. 8.

Subjects can be assigned treatment by accessing the system over IVRS or over internet. User is provided full control over site activation, shipment requests, shipment confirmation and shipment receipt confirmation.
Assign confirmed screening number once the candidate is eligible for screening through signing of consent form
Provide for fast and easy enrollment, thereby assisting in achieving sponsor targets—help monitor to ensure accurate candidate profiling
Subject status utility allows user to update subject's status with time
Provide for assignment of subject and kit number over IVRS or over the internet for both static and dynamic randomization
Allow just-in-time inventory control and provide for e-alerts and confirmation of drug shipment
Permit control on site activation
Provide for adaptive randomization
Allow break-blind on the fly
Send instant confirmation by fax and email
Enable sessions in many languages with speech recognition in addition to touch tone
Gets ready for enrollment within two weeks of notification
Handle both static and dynamic randomization
Provide for global access in multiple languages
Facilitate up to 24 concurrent sessions or its multiples
Permit replacement of subjects and kits
Provide for kit resupply based on predefined resupply algorithms
Allow for the micro scheduling of supplies
Allow for return of shipment there by providing complete account of dispensed drugs
Provide for voice mining

4. Randomization

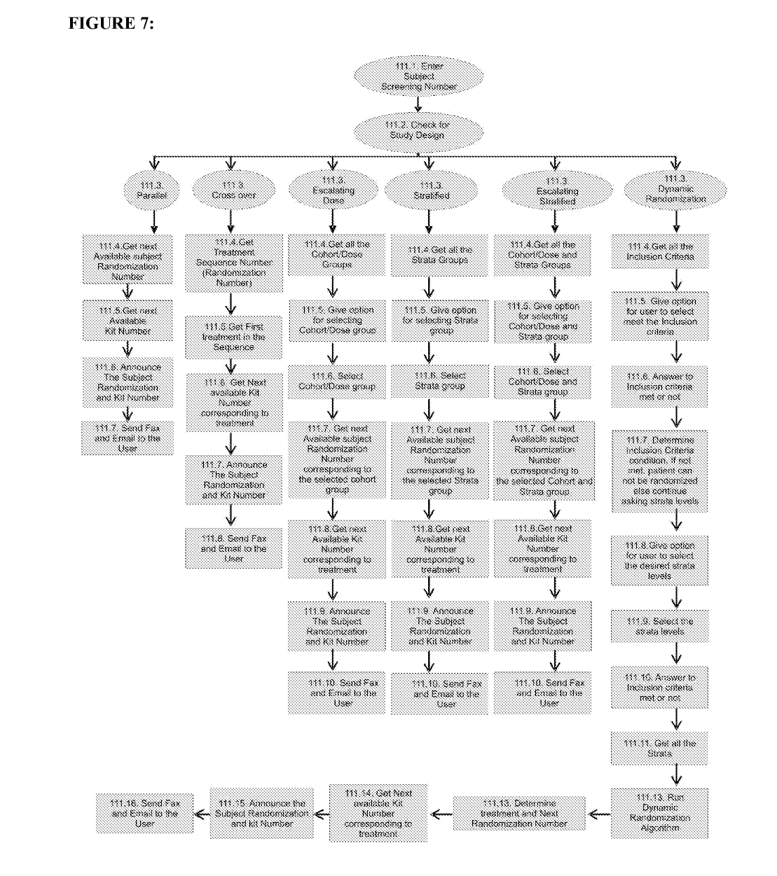

With reference to FIG. 7, which illustrates randomization of patient with respect to different study designs

### Static Randomization

Allow for scrambled random code generation for complete blinding
Provide for multiple models and block size within the same set of random codes
Permit up to eight-way cross over with first order effect
Facilitate stratified rising dose studies
Allow each update within the protocol to be independent of others
Generate subject and kit numbers from 1 to 999,999
Allow secured data transfer with real-time access to data
Allow logical deletion of random codes
Allow deletion of random codes at append level
Does not allow reversal of deletion of random codes
Deletion is possible only through authorized user
Allow copying of definition without copying seed and random codes
Allow downloading of random codes through excel and flat files
Allow report both in html and pdf formats

### Randomization

Allow up to sixteen strata
Provide for weighted treatments and strata
Manage inventory dynamically by tracking enrollment rate
Generate instant reports to view treatment distribution and balance across strata
Allow creating dynamic protocol definition, implementing complex statistical algorithm
Allow definition report both in html and pdf formats

### Adaptive Randomization

Implement complex randomization schemes such as Pocock Simon statistical algorithm
Provide for transparency for the sites when treatment arms are removed
Triggered inventory algorithm will recalculate the inventory at all sites
Removal of treatment arm will make the deactivation of previous appends automatically.

5. Adverse Event Reporting System (AERS):

The AE Reporting functionality/module provides all necessary assistance in dealing with safety reporting. Some of the features are listed below.
Provide instantaneous AE/SAE alerts
Provide for email notifications of AE/SAEs
Dictionary coding with auto encoding for MedDRA/WHO Drug dictionaries
Allow user to view dictionary and search dictionary term using various search techniques
Audit trail—Report showing audit trail for different data points
Provide for AE/SAE reconciliation
Provide for efficient tracking of AEs and SAEs

### AE/SAE Sample Reports

AE/SAE report—Report showing details of AE/SAEs occurred for different subjects and sites
Reconciliation report—Report showing AE/SAE reconciliations
Auto encoding report—Report showing details of auto encoded terms for MedDRA and WHO Drug

6. Pharmacovigilance:

Pharmacovigilance functionality offers a comprehensive solution for post marketing safety surveillance. It facilitates Signal Detection, and reporting of ICSRs, (Individual Case Safety Reports) SUSARs (Suspected Unexpected Serous Adverse Reactions) and PSURs (Periodic Safety Updates Reports) within the timelines to different regulatory authorities. Its unique integration with other modules of the system makes it one of the most effective pharmacovigilance tools of its generation. It manages all aspects of pharmacovigilance from configuration validation to international reporting. Since the system is built on a central repository and database, the response time for collection of SAE data and corresponding action is dramatically reduced.
Centralized safety data
Signal Detection
Reporting of ICSRs, SUSARs and PSURs
Report preparation and electronic submissions

7. Clinical Drug Labeling:

This is unique functionality that differentiates the system from the other systems. The functionality of system incorporates just-in-time inventory control of drug supply at the site that makes shipping requests and receipt confirmation over IVRS/IWRA.
Allow for the approval of labels over internet
Track drug expiration and retrieval
Permit scrambled kit number labeling
Generate quick labels and pre-production labels
Handle just-in-time (JIT) labeling and delivery
Create labels in multiple languages
Provide for expiration and relevant information traceability

### Inventory Status:

Provision to determine inventory status using bar coding and RFID (Radio-Frequency Identification) to enable Drug accountability.

8. Data Mining:

Data mining tool enables identification of potential subjects suitable for a given clinical trials based on disease characteristics and co-morbidity rates based on medical records or health records, imported from external sources or internal sources and provide for identifying safety and efficacy patterns based on trial data. Data mining starts with the preparation for statistical concept communications based on analytic strategies and come out with specific recommendation methodological solutions on complex analytic topics. This requires disease identification, cohort construction, mapping of healthcare resource utilization and expenditures to standard metrics for product value propositions, construction of drug coding systems to support database activities for key therapeutic research and development and brand Life Cycle Management (LCM) activities, and establishment and maintenance of a repository of the coding systems for therapeutic medications, diagnostic or surgical procedures.

9. Experimental Design:

The Experimental design functionality/module of the systems offers an integrated environment for designing the clinical trials. The Experimental design provides features to design a clinical trial according to the Number of Groups, Analysis Basis, Trial Endpoint, Sample Allocations and Data Plotting. The Experimental design statistical module that has nine integrated main components:
Classical Design (CD)—It provides number of methods for sample-size calculations. It includes methods for single-, two-, and multiple-group designs, and for superiority, equivalence and precision designs with various endpoints.
Sequential Design (SD)—A group sequential trial is usually a cost-effective design. SD covers a broad range of sequential trials with different endpoints and different types of stopping boundaries.
Multistage Design (MSD)—It provides three optimal designs among others: MinMax, MinExp, and MaxUtility, which minimize the maximum sample size, minimize the expected sample size, and maximize the utility index, respectively.
Dose—Escalation Design (DED)—It provides researchers with an efficient way to search for an optimal design for dose-escalation trials with a variety of criteria. It includes traditional escalation rules, restricted escalation rules, two-stage escalation algorithms, and the Bayesian continual reassessment method (CRM).
Dose—Escalation Trial Monitoring (DTM)—It assists in monitoring an ongoing DED trial. They inform the user if the stopping boundary has been crossed and will also generate interim results such as conditional power, new sample size required, and dynamic randomization to instruct the user to make appropriate dosages.
Adaptive Design (AD)—It is a design that allows modifications to some aspects of a trial after its initiation, without undermining the validity and integrity of the trial, such as sample-size re-estimation, dropping a loser, response-adaptive randomization, and biomarker-adaptive designs. The value addition of adaptive trial is illustrated in FIG. 10.
Adaptive Trial Monitoring (ATM)—It assist in monitoring an ongoing AD trial. It focuses on how to use statistical tools such as stopping boundaries, boundary-crossing probabilities, conditional power, and the futility index.
Adaptive Trial Simulator (ATS)—It allows you to simulate trials with very complex adaptive designs, which can be combinations of adaptations such as response-adaptive randomization, dropping losers, early efficacy or futility stopping, and sample-size re-estimation.
Randomizer (RAN)—It can generate random variates from a variety of distributions.

10. eDiary

This functionality/module of the system provides subjects interfaces to enter a subject's health status data via Personal Digital Assistants (PDA), Mobile, and Interactive Voice Response (IVR). The subjects' health status includes data relating to a number of areas like quality of life, health economics, efficacy etc.
Easy data transfers
Setting up of Alerts and Reminders for patient to enter assessment data
Multiple languages

11. Medical Imaging

Medical Imaging solution as part of functionality of the system brings more value in finding efficacy and safety evaluation. Information to and from the medical devices are communicated automatically. Users can analyze, edit and save the images using lot of features provided by medical imaging solution.
Picture Archiving and Communication System (PACS)
An information system that electronically stores, retrieves, transports, displays, prints, and manages digital clinical images
PACS replaces hard-copy based means of managing medical images, such as film archives
It provides capabilities of off-site viewing and reporting
PACS enables practitioners at various physical locations to access the same information simultaneously
Highly scalable in a large hospital environment without clogging networks with traffic
Accessible globally from any Internet-connected computers
Simple to use, simple to configure-all workstation needs is a Web browser
Provides the most sophisticated functionality (e.g. 3D image manipulation and others) on standard PCs and supports inexpensive printers
Open, compatible with all relevant standards
Computational Organ Dynamics—for quantitative study
Provide for image mining

12. Administration

The administration module of the system provides various features related to the handling of the system itself. It allows easy management of the system for administrators by providing some handy utilities.
Provide for creation of users, languages, countries and currencies
Provide access to different modules, roles and sub roles for different users
Allow association of users with protocols and management of user sessions
Allow unlocking of protocols
Allow viewing of system access logs and system related audit trails
FDA CFR Part 11 compliant

13. Data SQC (Sample Quality Control)

The functionality of the system assists the user in sampling the data during the trial for Quality Control (QC) and Quality Assurance (QA) of data entry that has already been made. The module uses a built-in algorithm to sample the entered data by allowing selection of different eCRFs and data points. It automatically calculates the maximum error allowed depending on the number of subjects enrolled in the trial thereby assisting in checking the quality of the data. It allows the user to enter values for some important parameters like Sample Rate to sample the data as required.
Provide for random sampling to perform quality control and assurance of captured data
Allow for setting up statistical parameters for expected quality level
Provide QA and QC Reports

14. Clinical Trial report (CTR)

The CTR Application supports the creation and publication of status reports of the clinical projects for individual protocols or pooled data from similar protocols. The resulting report is shown on management meetings and supports the decision to clinical projects/trials.
Data warehouse web application
Supports the decision on clinical project prioritization
Tracks/Forecasts the cost tracking of trials and projects
Supports the status of different trials in a clinical project using Gantt Chart with milestones
Tracks/Forecasts the patient enrollment
Central location for all reports
Avoids duplication of reports
Presents reports directly online (MS PowerPoint enabled)

15. Clinical Study Reports (CSR)

The CSR functionality is designed to enable the rapid creation of clinical study analysis datasets and standard safety table's listings and graphs for individual protocols or pooled data of similar protocols. Its web based graphical user interface allows targeted end users to review and produce tables and listings during the conduct of a clinical study. End users can customize content of a report through the use of sub setting and parameter selection options.
Data warehouse web application
Reduce the programming effort to create safety tables by standardizing the table/listings layout
Ensures quality and consistency of output by using validated code
End users will be familiar with the standard tables/listing layout that is being applied across all studies
Allows the end user to subset the data and selection of identified parameters to create dynamic reports
Provision for Global Data Management Report
Provision for XML archiving of SAS Datasets and Formats

16. Component Authoring

This module assembles key projects such as clinical development plan and submission and study documentation such as protocol and clinical study report from reusable content, structured fields such as title and ID, and free texts such as study objectives. Module guarantee absolute consistency of information across multiple publications or disclosures And directly incorporates information generated by analytical tools such as tables, graphs, charts. Some of the features are as follows:
Manages the entire life cycle of information as discrete components
Enables a collaborative approach to authoring and reviewing key documents
Maintains traceability of document components
Discloses information to multiple agencies whilst meeting their individual format and timing needs
Demonstrates alignment between objectives, end-points and data collected
Produces a CRF visualization from a draft time and events schedule.

17. Master Data Management

Master Data Management module describes and maintains reference data such as codelists, normal ranges, valid values and conversion factors. Module creates and assigns identifiers to data/information, such as investigator, site, and study and ensures that subsequent entries are matched to the same records. Some of the features are as follows:
Ensures that each module is synchronized in terms of business identifiers, their attributes, relationships and hierarchies
Provides access to appropriate master data to external partners in a controlled manner
Identifies data integrity issues and provides for traceability and audit trailing for all master data elements
Reconciles, enriches and shares data from multiple sources (internal and external) with multiple consumers
Ensures usage in all down-stream environments and provides for consistency of information

18. Standard Management

This modules defines the standard study objects such as groupings, datasets, eCRF screens code lists, based upon underlying defined concepts and business rules associated with those concepts. Module enables evolution and modification of the underlying definitions of the data in line with industry wide standards and other regulatory and safety requirements. Module is used to communicate and exchange clinical data, standards, standard art facts and study designs using industry standards some of the features are as follows:
Maintains the relationships between defined underlying concepts, the standard artifacts based on those concepts, such as data structures, and the CRF pages
Meets the emerging needs for provision of data for reporting, submissions, and disclosures conforming to industry standards
Makes available and applies standards and business rules in the end-to-end process from protocol authoring, through data capture to presentation of results, and report writing
Creates SDTM Trial Design datasets and subject-level datasets
   Creates AdaM compliant Analysis Datasets
   Provides for creation of eCRF as per CDASH standards and HL7 standards

19. Medical Writing:
Medical Writing module provide various, standards templates for the regulatory documents like INDs, NDAs, CTDs, IND annual reports, protocol and protocol amendments, IBs, CSRs, Subject and study narratives
Also, provided various, standards templates for publication documents.
The module helps to prepare manuscripts of higher quality and more quickly

### General Characteristics of the Systems:

The system is available in multiple language
The system is compliant to 21 CFR part 11 and HIPPA
The system is compliant to other industry standards like CDISC, CDASH, HL7, and ICH Guidelines
The system provides online and offline backup
The start up time is as low as 7 days
The system provides option for batch loading of data
The system provides multiple channels of access—Web, Phone, Fax, PDA
The system provides data archival in XML
System is capable of working using browser such as mozilla and internet explorer.

### The Advantages/Benefits the System and Method Offer:

Direct Access to Relevant Data—Real time patient results
Integrate databases
Data collected and cleaned rapidly and reliably—Queries resolved rapidly
Implementation capability—Review, decide and change rapidly
   Simulate adaptive algorithm and options
   Prepare for multiple interim analysis
   Endpoint data collection and enrollment rate compatible
Better quality decisions
   Dynamic adjustments for trial design
   Reduced sample size
   Clean data as you go
   Less data for sampling for quality control
Focus on “Interesting patients and treatments”
   Reduces uncertainty
   Minimizes blackout periods
   Enables stopping for futility
Cost Reduction and Revenue Enhancement
   Earlier application and submission
   Lower enrollment and cost per patient savings
   Effective resource managements using JIT
   Reduces setup time
   Improved expense control through CTMS
Statistical Validity—Control Type 1 error and parameter estimation
   Avoid premature assessment
   Use Dynamic Randomization (Pocock Simon algorithm)
Regulatory Acceptance—Eliminate opportunity to introduce Bias
   Create Scrambled Kits to avoid unblinding
Smart Supply—Effective Secondary packaging
   Introducing dummy placebos and least common denominator packaging
   Just-in-time labeling and inventory algorithm
   Account for re-supply surges

We claim:

1. A fully integrated, single transactional online system for end-to-end solution in mining, designing, managing, recording, analyzing and reporting of traditional as well as adaptive clinical trials comprising:
a single transactional system;
a reporting system;
an application server;
a web server;
an interactive voice response server; and
a communication network, wherein
the application server is configured to perform clinical trial functions, the web server coupled to the application server has a user interface to facilitate access to clinical trial functions over an internet based network, the communication network includes ISP (Internet Service Provider)/PSTN (Public Switched Telephone Network)/GSM, (Global System Mobile), the single transaction database uses multiple channels of communication, the system has a single transactional repository with a pyramidal architecture to take clinical trials from silos to fully integrated ones, the system has a single data login system which provides single data point of information and ensures smooth flow of the information from one component to others, and
the system provides real time update of the clinical trial that includes status of investigational sites, treatment effect, clinical study/program status, finances, clean data and safety data.

2. The fully integrated, single transactional online system as claimed in claim 1, wherein the transactional database system consists of a plurality of applications selected from the group consisting of clinical trial management system (CTMS), electronic data capture (EDC), e-diary, data mining, IVRS/IWRS (interactive voice/web response system), medical imaging, administration/security, clinical drug labeling, adverse event reporting system, randomization, experimental design, data SQC, and Pharmacovigilance.

3. The fully integrated, single transactional online system as claimed in claim 1, wherein the reporting system consists of a plurality of applications selected from the group consisting of data warehouse web application, clinical trial report, clinical study report, component authoring, master data management, standards management, and medical writing, wherein the data warehouse web application is built using business intelligence (BI) and data intelligence (DI) tools with ability to access real time mission critical information.

4. The fully integrated, single transactional online system as claimed in claim 2, wherein the clinical trial management system is configured to manage contacts, accounts, contracts and agreements to build protocols, construct and approve budgets, monitor payments, track protocol milestones, track site and patients status, upload and manage different kinds of documents, build templates for milestones, file checklist, visit report, to yield critical clinical trial status reports for management information.

5. The fully integrated, single transactional online system as claimed in claim 2, wherein the electronic data capture module is configured to transfer and/or obtain secured data in real-time from investigational sites.

6. The fully integrated, single transactional online system as claimed in claim 2, wherein the e-diary module provides interfaces to enter subject's health status data and quality of life, health economics and efficacy assessments via personal digital assistants (PDA), mobile, and interactive voice response system (IVRS).

7. The fully integrated, single transactional online system as claimed in claim 2, wherein the data mining tool enables identification of potential subjects suitable for a given clinical trials based on disease characteristics and co-morbidity rates based on electronic medical records and electronic health records and provide for identifying safety and efficacy patterns based on trial data.

8. The fully integrated, single transactional online system as claimed in claim 2, wherein the medical imaging module electronically stores, retrieves, transmits, displays and manages digital clinical images and enables computational organ dynamics for quantitative study.

9. The fully integrated, single transactional online system as claimed in claim 2, wherein the administration module is configured to provide features that include creation of users, languages, countries and currencies; access to different modules, roles and sub roles for different users; allowing association of users with protocols and management of user sessions; allowing unlocking of protocol; and allowing viewing of system access logs and system related audit trails.

10. The fully integrated, single transactional online system as claimed in claim 2, wherein the clinical drug labeling functionality is configured to control drug supply just-in-time by making shipping requests and receipt confirmation over interactive voice/web response system (IVRS/IWRA) using bar coding and Radio-Frequency Identification (RFID) to enable drug accountability.

11. The fully integrated, single transactional online system as claimed in claim 2, wherein the adverse event reporting system is configured to provide for instantaneous AE/SAE alerts, email notification of AE/SAEs, AE/SAEs reconciliation, efficient tracking of AEs and SAEs, dictionary coding with auto encoding for MedDRA/WHO Drug dictionaries and audit trail-report showing audit trail for different data points.

12. The fully integrated, single transactional online system as claimed in claim 2, wherein the randomization functionality is configured to manage inventory dynamically by tracking enrollment rate, generating instant reports to view treatment distribution and balance across strata, implement complex randomization schemes, provide for transparency for the sites when treatment arms are removed, allow secured data transfer with real-time access to date and allow logical detection of random codes.

13. The fully integrated, single transactional online system as claimed in claim 2, wherein the experimental design is configured to provide a clinical trial design according to the number of groups, analysis basis, trial endpoint, sample allocations and data plotting.

14. The fully integrated, single transactional online system as claimed in claim 2, wherein the data sampling quality control module samples the entered data by allowing selection of different e CRFs and data points and assesses whether the data is within a required quality limit based on quality control and quality assurance parameters and assists the user in sampling the data during the trial for quality control (QC) and quality assurance (QA) of data entry that has already been made.

15. The fully integrated, single transactional online system as claimed in claim 2, wherein the pharmacovigilance module is configured for post marketing safety surveillance, signal detection and reporting.

16. The fully integrated, single transactional online system as claimed in claim 3, wherein the clinical trial report application supports the creation and publication of status reports of the clinical projects for single or pooled protocols as a trial proceeds which provides vital information to the management group.

17. The fully integrated, single transactional online system as claimed in claims 3, wherein the clinical study reports functionality includes a web based graphical user interface which allows targeted end users to review and produce tables, listings and graphs as per ICH guidelines for single protocol or pooled protocols during the conduct of a clinical study.

18. The fully integrated, single transactional online system as claimed in claim 3, wherein the component authoring module assembles projects that include clinical development plan, submission and study documentation that includes protocol and clinical study report from reusable content, structured fields such as title and ID and free texts such as study objectives.

19. The fully integrated, single transactional online system as claimed in claim 3, wherein the master data management module describes and maintains reference data selected from the group consisting of code lists, normal ranges, valid values and conversion factors.

20. The fully integrated, single transactional online system as claimed in claim 3, wherein the standard management module characterizes the study objects selected from the group consisting of datasets, eCRF screens code lists, based upon underlying defined concepts and business rules associated with those concepts with eCRFs created as per CDISC CDASH standards, value added datasets created as per CDISC SDTM standards, and analysis data created as per CDISC AdaM compliant standards.

21. The fully integrated, single transactional online system as claimed in claim 3, wherein the medical writing module is configured to provide various standard templates for the regulatory documents that includes INDs, NDAs, CTDs, IND annual reports, protocol and protocol amendments, IBs, CSRs, subject and study narratives, publication documents and preparing manuscripts of higher quality.
